(19) United States
(12) Patent Application Publication
(10) Pub. No.: US 2012/0239515 A1
(43) Pub. Date: Sep. 20, 2012

(54) SYSTEMS AND METHODS FOR DYNAMIC PRODUCT AND SERVICE BUNDLING

(75) Inventors: Vishal Singh Batra, Noida (IN); Prasad Manikarao Deshpande, Mumbai (IN); Mukesh Kumar Mohania, Agra (IN); Ullas Balan Nambiar, Haryana (IN); Sumit Negi, New Delhi (IN)

(73) Assignee: INTERNATIONAL BUSINESS MACHINES CORPORATION, Armonk, NY (US)

(21) Appl. No.: 13/051,137

(22) Filed: Mar. 18, 2011

(51) Int. Cl. G06Q 30/00

(52) U.S. Cl. 705/26.1

(57) ABSTRACT

Systems and methods for dynamic product bundling are described herein. For example, embodiments dynamically generate product bundle for customer within a particular segment in view of that customer's interest in a particular product. Embodiments determine customer affinity, customer commonality, and product complementarity and use this information to dynamically generate and optimize product bundles for customers interested in one or more products.

### FIELD OF THE INVENTION

The subject matter presented herein generally relates to dynamically generating bundles of products, services, or combinations thereof.

### BACKGROUND

Sales agents often encounter situations where a customer has expressed interest in a product or service but wants to negotiate a lower price, for example, a price that is more “market competitive.” However, such negotiating would require an agent to quickly decide on how to lower the price for the product without taking a loss. One common approach is “product bundling,” which involves combining other products or services that may be of interest to a customer in lieu of lowering the price for the initial item of interest.

Configuring product bundles involves considering multiple factors, including which products and services are actually complementary, and of these, which should be bundled together and at what price. These considerations require a seller to have good information regarding current and potential customers, especially their product interests and the prices they are willing to pay. However, this information is dynamic and constantly subject to change. As a result, bundled product and service offerings often do not adequately capture potential profits or lose effectiveness in the face of changing conditions.

### BRIEF SUMMARY

In summary, one aspect provides a system comprising: at least one processor; a system memory operatively coupled to the at least one processor; and at least one product bundling module communicatively coupled to the system memory, wherein the at least one product bundling module is adapted to: access at least one source of customer information; access at least one source of product information; receive a selection of at least one main product by at least one customer; and dynamically generate at least one product bundle comprising at least one main product selected by at least one customer and at least one ancillary product, wherein generating the product bundle is based on the customer information and the product information.

Another aspect provides a method comprising: accessing at least one source of customer information; accessing at least one source of product information; receive a selection of at least one main product by at least one customer; and dynamically generating at least one product bundle comprising at least one main product selected by at least one customer and at least one ancillary product, wherein generating the product bundle is based on the customer information and the product information.

A further aspect provides a computer program product comprising: a computer readable storage medium having computer readable program code embodied therewith, the computer readable program code comprising: computer readable program code configured to access at least one source of customer information; computer readable program code configured to access at least one source of product information; computer readable program code configured to receive a selection of at least one main product by at least one customer; and computer readable program code configured to generate at least one product bundle comprising at least one main product and at least one ancillary product, wherein generating the product bundle is based on the customer information and the product information.

A still further aspect provides a system comprising: at least one processor; a system memory operatively coupled to the at least one processor; and at least one product bundling module communicatively coupled to the system memory, wherein the at least one product bundling module is adapted to: generate at least one product bundle comprising at least one main product selected by at least one customer, at least one ancillary product, and a main product differential pricing requested by the at least one customer; wherein the main product discount is offset by a cumulative profit of the at least one product bundle.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE DRAWINGS

FIG. 1 provides example architecture of a system configured to dynamically generate product bundles.

FIG. 2 provides an example of dynamic product bundling.

FIGS. 3A and 3B provide tables of financial figures for an example financial institute.

FIG. 4 illustrates an example computer system.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the claims, but is merely representative of those embodiments.

Reference throughout this specification to “embodiment(s)” (or the like) means that a particular feature, structure, or characteristic described in connection with the embodiment is included in at least one embodiment. Thus, appearances of the phrases “according to embodiments” or “an embodiment” (or the like) in various places throughout this specification are not necessarily all referring to the same embodiment.

Furthermore, the described features, structures, or characteristics may be combined in any suitable manner in one or more embodiments. In the following description, numerous specific details are provided to give a thorough understanding of example embodiments. One skilled in the relevant art will recognize, however, that aspects can be practiced without one or more of the specific details, or with other methods, components, materials, et cetera. In other instances, well-known structures, materials, or operations are not shown or described in detail to avoid obfuscation.

Configuring a product or service bundling strategy requires knowledge of demand for complementary products and services. From a customer's point of view, product bundling is most effective if the suggested products are of potential interest to the customer (i.e. complementary to the main product) and if the overall cost of the purchase shows a savings compared to purchasing each product individually. For a vendor, a product bundle may be considered successful if profits derived from the bundled products at least offset the price reduction to the initial product. As indicated above, product bundling is not limited to tangible products, but may also be comprised of services or a combination of products and services. Throughout this specification, use of the term “product,” “product bundle,” or variations thereof are used for clarity and to avoid obfuscation. Thus, use of these terms throughout the specification also encompasses the term “service,” “services,” or some variation thereof, if applicable.

Current technology mainly provides for “static bundling,” which involves pre-computing product bundles and associated discounts. Most work in this area has focused on finding product pairs. A prominent drawback of static bundling is that it is not effective when the profits derived from a bundle depend on time-sensitive and/or customer-specific attributes. For example, an enterprise is contemplating creating a two-product bundle around a main product A and a second product B, wherein the discount offered on the main product may be determined by the following: d_{A}<=profit({x_{A}}, {x_{B}}). Time-sensitive attributes that may affect profit, for example, in a scenario involving financial products, include prevailing risk-free interest rates and current market lending rates. Customer-specific attributes that may affect profit, for example, in a scenario involving insurance products, may include age, profession, or customer lifetime value.

In addition, current product bundling methods, and static bundling in particular, are simply not feasible in certain situations, such as when product bundles and associated discounts cannot be pre-computed. For example, pre-computation of these factors may not be possible or practical when there is potential for exponential combinations of customers and products. Typical solutions according to existing technology include clustering products into groups and customers into segments, identifying potential product bundles for a given customer segment and suggesting the bundle to all customers in the segment, and refining product bundles or customer segments based on feedback. According to these methods, clustering products into groups may involve grouping based on chosen criteria, such as how well products complement each other and purchase affinity, while segmenting customers may be based on Close Location Value (CLV), demographics, and purchase patterns. However, such solutions have proven to have several limitations. For example, these product bundling methods do not take into account a customer's interests and cross-product interactions, and they become difficult to use when bundle sizes are not restricted to only two products or services.

Embodiments provide for systems and methods for dynamic product bundling. In addition, embodiments provide for dynamically computing customized product bundles. Furthermore, embodiments provide for configuring product bundles of all possible bundle sizes. According to an embodiment, a product bundle (P_{b}) may be dynamically assembled for a customer (C) within a particular segment (S) in view of that customer's interest in a particular product (p), for example, according to the following:

P_{b}={p, p₁, p₂. . . p_{n}}
where ∀pᵢ≠p, C∈S,
CustomerAffinity(C, pᵢ)≧SegmentAffinity (S, pᵢ)
and
Complementary(p, pᵢ).
   Embodiments provide for bundling products through, inter alia, computing product complementarity and customer affinity. Certain embodiments group products by complementarity of utility and/or group customers by commonality, including, but not limited to, commonality in business transactions or demographic details. According to an embodiment, a customer may purchase a product P at a discount D of the customer's choosing in view of the customer's affinity for other products and the complementarity of products as indicated by certain characteristics, including, but not limited to, functionality, business line, and ease of delivery. Embodiments provide that a seller may offset the discount D by the cumulative profit on other products in the bundle.

A non-limiting example of providing a “best subscription package” to one or more telecommunication service provider (“telco”) customers serves as an illustrative sector for product bundling according to embodiments. For telcos, a main problem stems from the fact that there are hundreds, if not thousands, of subscription packages at any given time. This creates a situation with a vendor having a large number of available products. These subscription packages are often called “price plans” and are typically issued by telco marketing departments depending on need, seasonal cycles, or market conditions. In addition, these plans often vary across customer type (e.g., residential, corporate, government) and geography (e.g., telecom circle, city). Furthermore, the plans may be composite services comprised of many basic services and, as such, may be modified easily by sales agents in an effort to suit customers. Thus, these price plans exhibit bundling feasibility.

Another advantageous feature of telco subscription services is the wealth of historical data available for use in product bundling decision making For example, data is available regarding customer-segment affinity to basic services, such as customer preferences for data service or international subscriber dialing (ISD) functionality, and the telco profit margins for different services. In addition, telco services are easily categorized, for example, into voice, data, and value added services (VAS).

Product bundling involves working under certain assumptions. For example, one conventional assumption is that marginal costs are constant with respect to output and there are no fixed costs. Other typical assumptions are that the benefit to a customer for a second unit of the same product is zero, and that resale amongst customers is nonexistent. Another classical product bundling assumption is that customers are profit maximizing, such that purchasing nothing yields zero profit to customer. In addition, certain modified product bundling assumptions may be utilized with embodiments as described herein. A first modified assumption is that the reservation price, which is the maximum price the customer is willing to pay, for all customer-product pairs is not known, except for the product chosen by the customer. A second modified assumption is that the seller does not have a monopoly, or variation thereof, over the product.

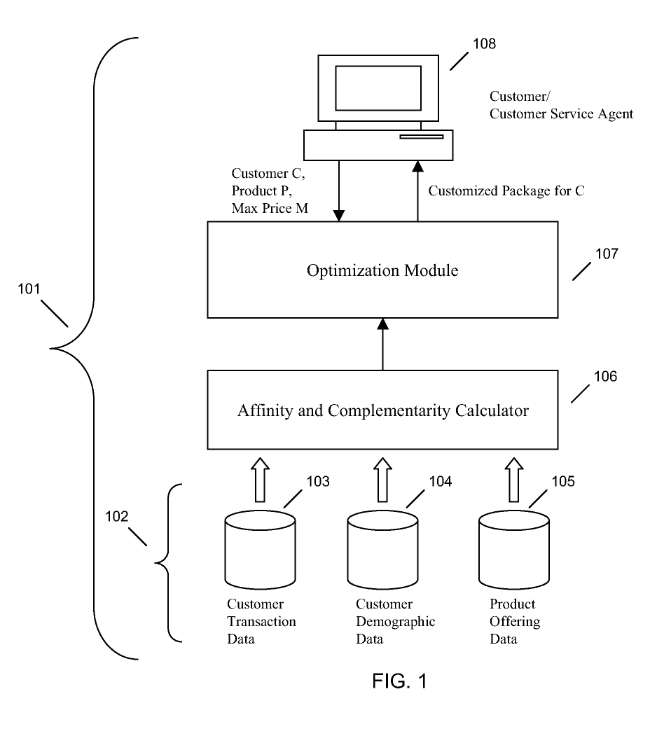

Referring to FIG. 1, therein is depicted example architecture of a system configured to dynamically generate product bundles according to an embodiment. The product bundling system 101 contains historical data 102. In the embodiment depicted in FIG. 1, the historical data 102 is comprised of customer transaction data 103, customer demographic data 104, and product offering data 105. An affinity and complementarity calculator 106 may access the historical data 102 and produce affinity and complementarity information for the given data set. The affinity and complementarity information may be accessed by an optimization module 107 that may use this information to generate or optimize product bundles. A customer computing system 108, which may be used, for example, by a customer or a customer sales agent, receives customized packages and product bundles from and sends information to the optimization module 107. For example, the customer computing system 108 may send customer name, product, and maximum price information to the optimization module 107.

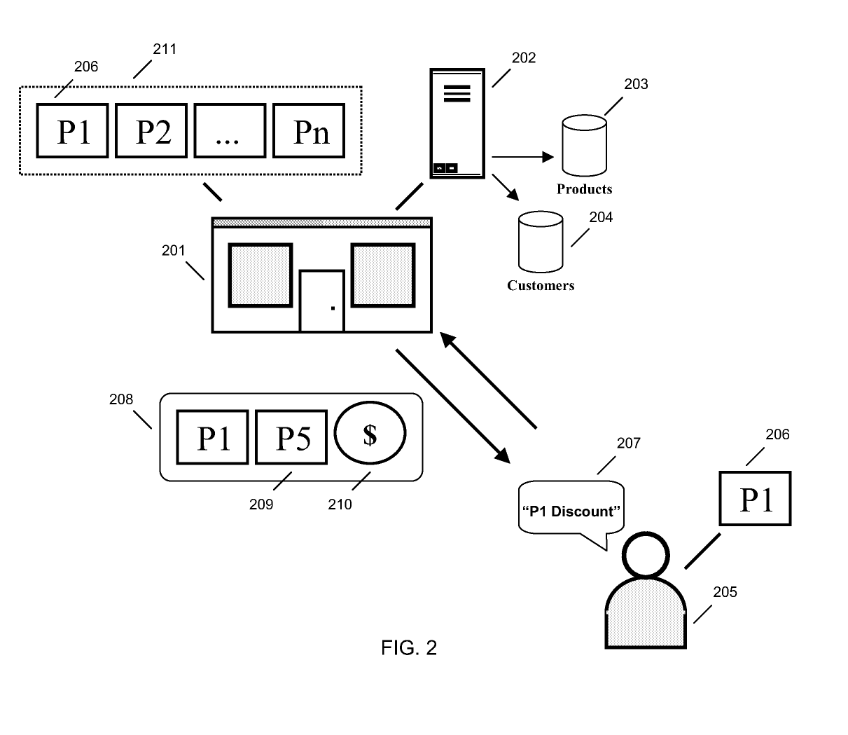

Referring to FIG. 2, therein is depicted an example of dynamic product bundling according to an embodiment. A vendor 201 sells a set of products 211 and utilizes a computing system 202 that accesses product data 203 and customer data 204. For example, embodiments provide that product data may be comprised of complementarity of utility information, and customer data may be comprised of information concerning grouping customers by commonality in business transactions and demographic details. A customer 205 is interested in a main product 206 and communicates a discount request 207 to the vendor 201. The computing system 201 responds by dynamically generating a product bundle 208 in responsive to the customer's 205 discount request 207. The product bundle 208 is comprised of the main product 206 bundled with one or more ancillary products 209 and a bundle price 210. According to embodiments, the product bundle 208 may be configured to offset any discount given to the customer 205 by, for example, the cumulative profit generated on the other products in the product bundle 208.

Embodiments provide for computing product complementarity and product affinity given a transaction dataset R containing information concerning a customer C and purchased products P. According to embodiments, complementarity may be expressed as the process Complementarity({P1,P2}, R) and is a measure involving the bundling feasibility of products P1 and P2. The process Complementarity({P1,P2}, R) may be computed by lift(P1→P2)=lift(P1→P2)=Support(P1∪P2)/Support(P1)×Support(P2), where Support(P) is the proportion of transactions containing product P.

Affinity may be expressed according to embodiments as the process Affinity(C, {P1, P2}) and is the measure of a customer C preferring the combination {P1, P2}. According to embodiments, affinity may be computed as the process Complementary ({P1, P2},Rc) *max(Affinity(C, {P1}), Affinity(C, {P2}), where Rc is a subset of R containing only transactions done by customer C. In addition, (Affinity(C, {P1})=Support(P1)/max(Support(Pi)), where Pi equals all of the products purchased by customer C. For certain customers, such as new customers, historical data may not be available. According to embodiments, customers lacking historical data (i.e., Rc), may be processed using historical data involving similar customers. In addition, if transaction data is not available, such as for new products, then embodiments provide that transaction data for similar products may be utilized.

Embodiments further provide for dynamically determining product bundles according to a process that does not rely on affinity and complementarity. Given the assumption that a second product of a unit is useless, any product may only appear once in a bundle, thereby making this process similar to a 0-1 knapsack, or, more generally, a bounded knapsack, problem. In general, a 0-1 knapsack problem is NP-complete, but has a pseudo-polynomial time algorithm. Accordingly, embodiments may be modeled as a 0-1 knapsack process where the discount D offered on the customer's chosen product x may be offset by the cumulative profit of the product bundle. One embodiment is demonstrated by the following:

minΣᵢ₌₁ⁿpᵢxᵢ
subject to Σᵢ₌ᵢⁿmᵢxᵢ≧D
where xᵢ ∈ {0,1},
   where xᵢ is a product being sold by a provider and is not the same as the product chosen by the customer; pᵢ is the price of product xᵢ; and mᵢ is the profit obtained by a seller on product xᵢ.

Certain other embodiments provide for dynamically configuring product bundles utilizing affinity and complementarity. Maximizing processes for these two constraints modifies the process into an m-dimensional, or multi-constrained, knapsack process. An m-dimensional knapsack process is NP-complete and has a pseudo-polynomial time algorithm. Embodiments utilizing affinity and complementarity may be described as follows:

minΣᵢ₌₁ⁿpᵢxᵢ
subject to Σᵢ₌ᵢⁿm_{i,j}xᵢ≧bⱼ
where xᵢ ∈ {0,1} and 1<j<3,
   where xᵢ is a product being sold by a provider and is not the same as the product chosen by the customer; pᵢ is the price of product xᵢ; mᵢ₁ is the profit, mᵢ₂ is the affinity and mᵢ₃ is the complementarity of product xᵢ; and b₁ is the maximum discount required, b₂ is the bundle affinity, and b₃ is the bundle compatibility.

Embodiments provide for dynamically configuring product bundles in response to a customer's request for differential pricing (e.g., price discount) or other similar seller concessions. For example, embodiments dynamically generate product bundles based on, inter alia, customer attributes, including, but not limited to, customer affinity, and product complementarity, such as complementarity based on product usage or business sector.

According to current technology, product bundles are configured statically and are offered at a time far removed from when they were created. In addition, configuring a bundle individualized for a particular customer according to current methods is a time-consuming, manual process. Embodiments provide for automatically and dynamically generating product bundles customized for each customer and product the customer may be interested in. As such, configuring product bundles according to embodiments overcomes the barriers exhibited by current technology, such as by reducing overhead, enabling a system that provides dynamic product bundling to be used even for lower value transactions, such as those in retail or telecom.

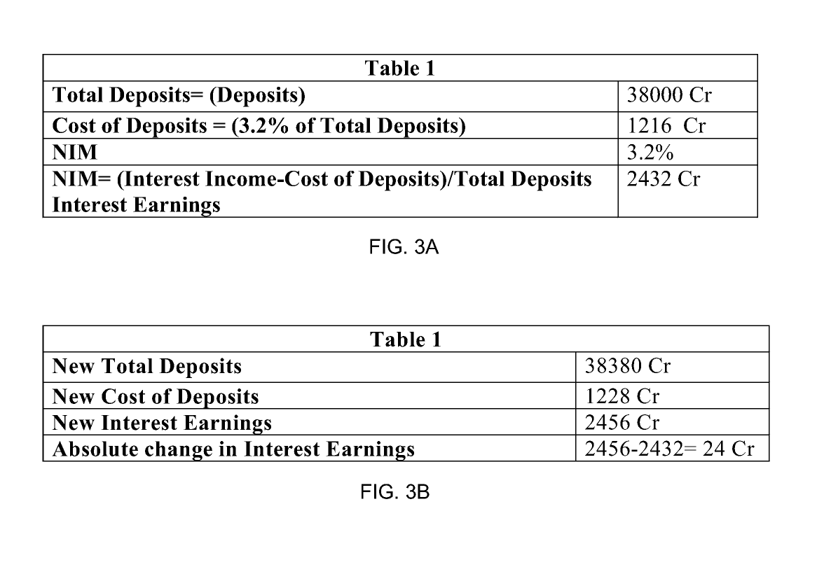

A financial services institution, such as a bank, serves as a non-limiting example of dynamic product bundling according to embodiments, wherein the bank increases its net interest margin (NIM), which has a strong influence on a financial institution's profit. NIM is a measure of the difference between the interest income generated by financial institutions and the amount of interest paid out to their lenders, such as for interest bearing deposit accounts, relative to the amount of their assets. This non-limiting example considers the impact on NIM for a financial institution if it is able to increase its total deposits by acquiring new customers and/or cross-selling financial products to existing ones. Referring to FIGS. 3A-3B, therein is depicted Table 1 301A providing the financial figures for an example financial institute over the period of one year. Assuming no change in the prime lending rate (PLR), the cost of deposits and the margin on each financial product remain unchanged. However, if deposits increase by just 1% respectively on account of new customer acquisitions and/or cross-selling of financial products to existing customers, the financial data may appear as in Table 2 301B. Embodiments provide for dynamically configuring product bundles. Such product bundles may be used to both obtain new customers and increase the number of financial products per customer. As demonstrated in this non-limiting example, such dynamic product bundling may lead to increased revenue and profits for a vendor or institution with minimal financial and resource expenditure.

In addition, providing dynamic product bundles according to embodiments may be utilized in virtually any field where benefits would be derived from such processes. For example, in a retail setting, dynamic product bundling may be used to create dynamic packages to users browsing a retail web site. Since buying a set of products is a one-time transaction, there would be no overhead beyond the transaction, so an increase in sales would lead to an increase in profit. As discussed above, in the financial and banking setting, embodiments may be used to create customized packages, including bundles containing loan and investment products. In this case, since the transactions are typically of high value, the overhead of managing customized packages may be offset by the profit made by increased sales. In the telecom domain, such bundled packages may be comprised of services that will be used over a time period. Overhead may also be reduced by creating customized packages for each customer segment, rather than for each individual customer

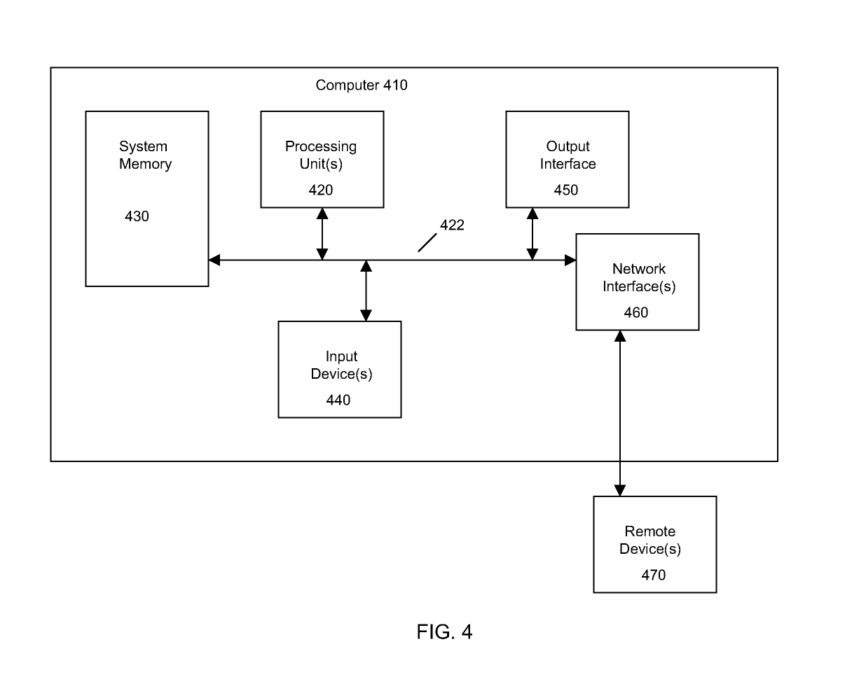

Referring to FIG. 4, it will be readily understood that certain embodiments can be implemented using any of a wide variety of devices or combinations of devices. An example device that may be used in implementing one or more embodiments includes a computing device in the form of a computer 410. In this regard, the computer 410 may execute program instructions configured to access at least one source of customer information; access at least one source of product information; and dynamically generating product bundles based on the customer information and the product information.

Components of computer 410 may include, but are not limited to, a processing unit 420, a system memory 430, and a system bus 422 that couples various system components including the system memory 430 to the processing unit 420. The computer 410 may include or have access to a variety of computer readable media. The system memory 430 may include computer readable storage media in the form of volatile and/or nonvolatile memory such as read only memory (ROM) and/or random access memory (RAM). By way of example, and not limitation, system memory 430 may also include an operating system, application programs, other program modules, and program data.

A user can interface with (for example, enter commands and information) the computer 410 through input devices 440. A monitor or other type of device can also be connected to the system bus 422 via an interface, such as an output interface 450. In addition to a monitor, computers may also include other peripheral output devices. The computer 410 may operate in a networked or distributed environment using logical connections to one or more other remote computers or databases. The logical connections may include a network, such local area network (LAN) or a wide area network (WAN), but may also include other networks/buses.

It should be noted as well that certain embodiments may be implemented as a system, method or computer program product. Accordingly, aspects may take the form of an entirely hardware embodiment, an entirely software embodiment (including firmware, resident software, micro-code, et cetera) or an embodiment combining software and hardware aspects that may all generally be referred to herein as a “circuit,” “module” or “system.” Furthermore, aspects may take the form of a computer program product embodied in one or more computer readable medium(s) having computer readable program code embodied therewith.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, et cetera, or any suitable combination of the foregoing.

Computer program code for carrying out operations for various aspects may be written in any combination of one or more programming languages, including an object oriented programming language such as Java™, Smalltalk, C++ or the like and conventional procedural programming languages, such as the “C” programming language or similar programming languages. The program code may execute entirely on a single computer (device), partly on a single computer, as a stand-alone software package, partly on single computer and partly on a remote computer or entirely on a remote computer or server. In the latter scenario, the remote computer may be connected to another computer through any type of network, including a local area network (LAN) or a wide area network (WAN), or the connection may be made for example through the Internet using an Internet Service Provider.

Aspects are described herein with reference to flowchart illustrations and/or block diagrams of methods, apparatuses (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Although illustrated example embodiments have been described herein with reference to the accompanying drawings, it is to be understood that embodiments are not limited to those precise example embodiments, and that various other changes and modifications may be affected therein by one skilled in the art without departing from the scope or spirit of the disclosure.

What is claimed is:

1. A system comprising:
at least one processor;
a system memory operatively coupled to the at least one processor; and
at least one product bundling module communicatively coupled to the system memory, wherein the at least one product bundling module is adapted to:
access at least one source of customer information;
access at least one source of product information;
receive a selection of at least one main product by at least one customer; and
dynamically generate at least one product bundle comprising the at least one main product and at least one ancillary product, wherein generating the product bundle is based on the customer information and the product information.

2. The system according to claim 1, wherein the at least one product bundle is dynamically generated responsive to the at least one customer requesting differential pricing on the at least one main product.

3. The system according to claim 1, wherein the customer information comprises customer transaction data and customer demographic data;
wherein the product information comprises product offering data.

4. The system according to claim 1, further comprising at least one complementarity calculator for determining at least one product complementarity of the at least one main product and the at least one ancillary product using the at least one product information source.

5. The system according to claim 4, wherein the complementarity calculator determines complementarity based on functionality.

6. The system according to claim 4, wherein the complementarity calculator determines complementarity based on a bundling feasibility of the at least one main product and the at least one ancillary product.

7. The system according to claim 4, further comprising at least one affinity calculator for determining at least one customer affinity of the at least one customer based on the customer information.

8. The system according to claim 7, wherein the affinity calculator determines the at least one customer affinity based on a measure of a customer preferring a combination comprising the at least one main product and the at least one ancillary product.

9. The system according to claim 7, wherein generating at least one product bundle is based on the at least one product complementarity and the at least one customer affinity.

10. The system according to claim 7, further comprising at least one optimization module adapted to:
receive input comprising the at least one customer affinity, the at least one product complementarity, the at least one main product, the at least one customer, and at least one main product maximum price; and
customize at least one product bundle package for the at least one customer based on the received input.

11. A method comprising:
accessing at least one source of customer information;
accessing at least one source of product information;
receiving a selection of at least one main product by at least one customer; and
dynamically generating at least one product bundle comprising the at least one main product and at least one ancillary product, wherein generating the product bundle is based on the customer information and the product information.

12. The method according to claim 11, wherein the at least one product bundle is dynamically generated responsive to the at least one customer requesting differential pricing on the at least one main product.

13. The method according to claim 11, wherein the customer information comprises customer transaction data and customer demographic data;
wherein the product information comprises product offering data.

14. The method according to claim 11, further comprising:
determining at least one product complementarity of the at least one main product and the at least one ancillary product using the at least one product information source.

15. The method according to claim 14, wherein determining the at least one product complementarity is based on functionality.

16. The method according to claim 14, wherein determining the at least one product complementarity is based on a bundling feasibility of the at least one main product and the at least one ancillary product.

17. The method according to claim 14, further comprising:
determining at least one customer affinity of at least one customer based on the customer transaction data.

18. The method according to claim 17, wherein the affinity calculator determines the at least one customer affinity based on a measure of a customer preferring a combination comprising the at least one main product and the at least one ancillary product.

19. The method according to claim 17, wherein generating at least one product bundle is based on the at least one product complementarity and the at least one customer affinity.

20. A computer program product comprising:
a computer readable storage medium having computer readable program code embodied therewith, the computer readable program code comprising:
computer readable program code configured to access at least one source of customer information;
computer readable program code configured to access at least one source of product information;
computer readable program code configured to receive a selection of at least one main product by at least one customer; and
computer readable program code configured to generate at least one product bundle comprising the at least one main product and at least one ancillary product, wherein generating the product bundle is based on the customer information and the product information.

21. A system comprising:
at least one processor;
a system memory operatively coupled to the at least one processor; and
at least one product bundling module communicatively coupled to the system memory, wherein the at least one product bundling module is adapted to:
generate at least one product bundle comprising at least one main product selected by at least one customer, at least one ancillary product, and a main product differential pricing requested by the at least one customer;
wherein the main product differential pricing is offset by a cumulative profit of the at least one product bundle.
